(19) United States
(12) Patent Application Publication
(10) Pub. No.: US 2020/0223044 A1
(43) Pub. Date: Jul. 16, 2020

(54) DRIVER BLADE

(71) Applicant: MILWAUKEE ELECTRIC TOOL CORPORATION, Brookfield, WI (US)

(72) Inventors: Ou Yang XIAO CHUAN, Dongguan (CN); David A. BIERDEMAN, New Berlin, WI (US)

(21) Appl. No.: 16/743,035

(22) Filed: Jan. 15, 2020

(30) Foreign Application Priority Data
Jan. 15, 2019 (CN) 201910035237.6

(51) Int. Cl. B25C 1/04; C22C 38/22; C22C 38/24; C22C 38/04; C22C 38/02

(52) U.S. Cl. CPC B25C 1/047; C22C 38/22; B25C 1/06; C22C 38/04; C22C 38/02; C22C 38/24

(57) ABSTRACT

A driver blade, for use with a powered fastener driver, includes an elongated body defining a longitudinal axis. The body includes a top surface and a bottom surface opposite the top surface. A first edge extends between the top surface and the bottom surface. The driver blade further includes a plurality of teeth formed along the first edge and extending in a direction transverse to the longitudinal axis. The driver blade is manufactured using a metal injection molding process.

### CROSS-REFERENCE TO RELATED APPLICATIONS

This application claims foreign priority to Chinese Patent Application No. 201910035237.6 filed on Jan. 15, 2019, the entire contents of which are incorporated herein by reference.

### FIELD OF THE INVENTION

The present invention relates to powered fastener drivers, and more particularly to a driver blade for use with a powered fastener driver.

### BACKGROUND OF THE INVENTION

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.) to drive a driver blade from a top-dead-center position to a bottom-dead-center position.

### SUMMARY OF THE INVENTION

The invention provides, in one aspect, a driver blade for use with a powered fastener driver. The driver blade includes an elongated body defining a longitudinal axis. The body includes a top surface and a bottom surface opposite the top surface. A first edge extends between the top surface and the bottom surface. The driver blade further includes a plurality of teeth formed along the first edge and extending in a direction transverse to the longitudinal axis. The driver blade is manufactured using a metal injection molding process.

The invention provides, in another aspect, a method of manufacturing a driver blade for use with a powered fastener driver. The method includes mixing a first material in powder form with a binder composition to yield a first feedstock mixture. The method further includes injecting the first feedstock mixture into a mold to form a rough driver blade. The method further includes removing the binder composition from the rough driver blade, and heat treating the rough driver blade to reduce the porosity of the rough driver blade to yield a finished driver blade that is usable in the powered fastener driver.

Other features and aspects of the invention will become apparent by consideration of the following detailed description and accompanying drawings.

### BRIEF DESCRIPTION OF THE DRAWINGS

FIG. 1 is a perspective view of a powered fastener driver in accordance with an embodiment of the invention.

FIG. 2 is a perspective view of a driver blade of the powered fastener driver of FIG. 1.

FIG. 3A is a perspective view of another driver blade embodying the invention.

FIG. 3B is a side view of the driver blade of FIG. 3A.

FIG. 4 is a schematic of a process for manufacturing the driver blade of FIG. 2 or FIGS. 3A-3B.

FIG. 5 is a plan view of yet another driver blade embodying the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

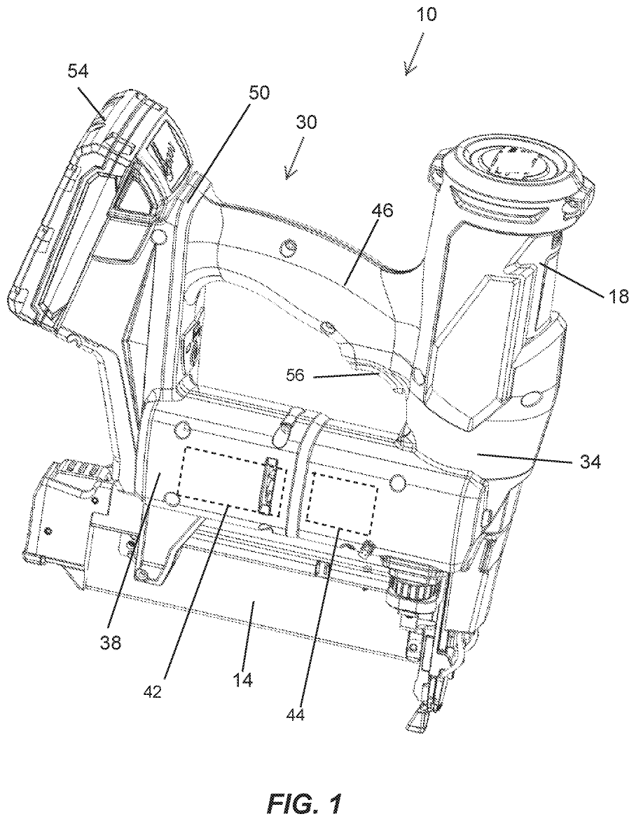

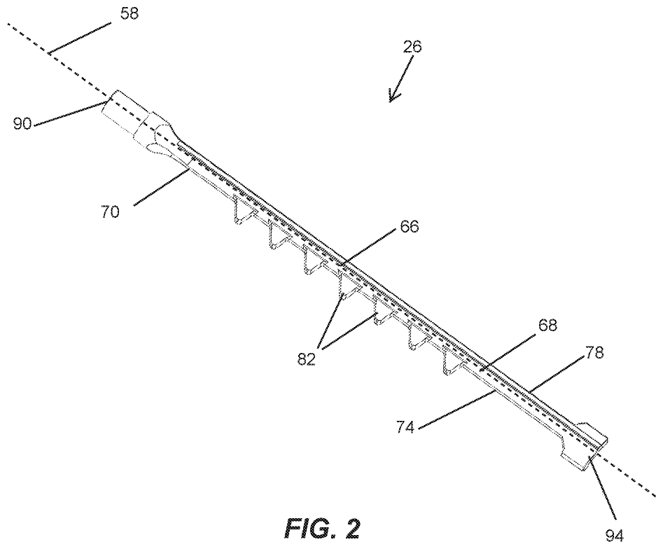

With reference to FIG. 1, a gas spring-powered fastener driver 10 is operable to drive fasteners (e.g., nails, tacks, staples, etc.) held within a magazine 14 into a workpiece. The fastener driver 10 includes a cylinder 18. A moveable piston (not shown) is positioned within the cylinder 18. With reference to FIG. 2, the fastener driver 10 further includes a driver blade 26 that is attached to the piston and moveable therewith. The fastener driver 10 does not require an external source of air pressure, but rather includes pressurized gas in the cylinder 18.

With reference to FIG. 1, the fastener driver 10 includes a housing 30 having a cylinder housing portion 34 and a motor housing portion 38 extending therefrom. The cylinder housing portion 34 is configured to support the cylinder 18, whereas the motor housing portion 38 is configured to support a motor 42 and a transmission 44 downstream of the motor 42. In addition, the illustrated housing 30 includes a handle portion 46 extending from the cylinder housing portion 34, and a battery attachment portion 50 coupled to an opposite end of the handle portion 46. A battery 54 is electrically connectable to the motor 42 for supplying electrical power to the motor 42. The handle portion 46 supports a trigger 56, which is depressed by a user to initiate a driving cycle of the fastener driver 10.

With reference to FIG. 2, the driver blade 26 defines a longitudinal axis 58. During a driving cycle, the driver blade 26 and piston are moveable between a top-dead-center (TDC) or ready position within the cylinder 18, and a bottom-dead-center (BDC) or driven position, along the axis 58. The fastener driver 10 further includes a lifter assembly (not shown), which is powered by the motor 42 (FIG. 1), and which is operable to return the driver blade 26 from the driven position to the ready position.

With continued reference to FIG. 2, the driver blade 26 includes an elongated body 66 having a first planar surface (i.e., a front surface 68) and an opposite, second planar surface (i.e., a rear surface 70). A first edge 74 extends between the front surface 68 and the rear surface 70 along one lateral side of the body 66, and a second edge 78 extends between the front surface 68 and the rear surface 70 along an opposite lateral side of the body 66. The front surface 68 is parallel to the rear surface 70. Likewise, the edges 74, 78 are also parallel.

The driver blade 26 includes a plurality of lift teeth 82 formed along the first edge 74 of the body 66. The first edge 74 extends in the direction of the axis 58, and the lift teeth 82 project from the first edge 74 in a direction transverse to the axis 58. The lift teeth 82 are sequentially engaged with the lifter assembly during the return of the driver blade 26 from the driven position to the ready position.

The driver blade 26 further includes a first end 90 and a second end 94 opposite the first end 90. The front and rear surfaces 68, 70, and the first and second edges 74, 78, extend between the first and second ends 90, 94. In the illustrated embodiment of the driver blade 26, the first end 90 includes a threaded post for connection with the piston. The second end 94 of the driver blade 26 is oriented perpendicular to the axis 58 for striking fasteners fed from the magazine 14 and driving the fasteners into a workpiece.

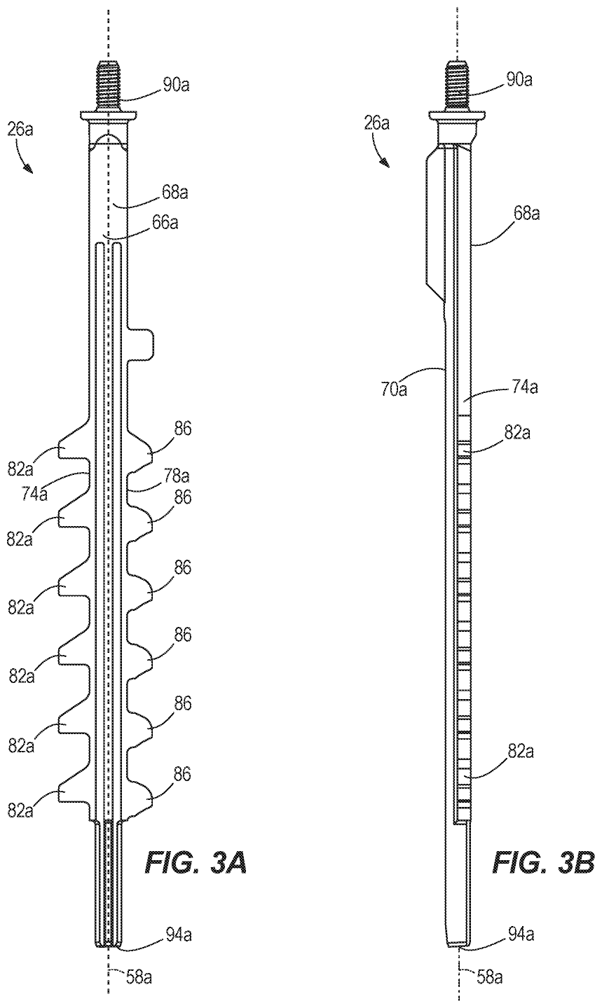

FIGS. 3A-3B illustrate another driver blade 26a embodying the invention, with like reference numerals with the letter “a” assigned to like features as the driver blade 26 shown in FIG. 2. The driver blade 26a includes a plurality of lift teeth 82a extending from a first edge 74a. In addition, the driver blade 26a includes a plurality of projections 86 extending from a second edge 78a. In particular, the projections 86 extend from the second edge 78a in a direction transverse to the longitudinal axis 58a. In one embodiment, the plurality of projections 86 are configured to engage a latch (not shown) of the fastener driver 10 for inhibiting the driver blade 26a from moving toward the driven position.

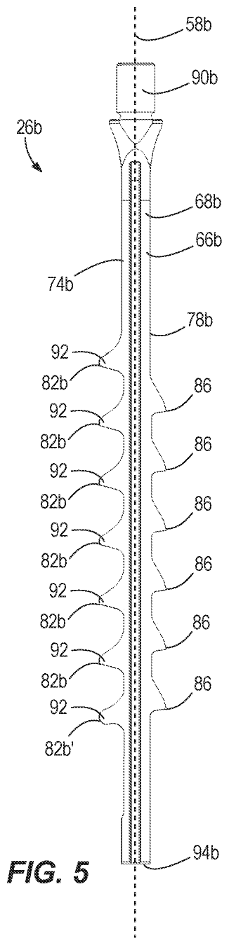

FIG. 5 illustrates another driver blade 26b embodying the invention, with like reference numerals with the letter “b” assigned to like features as the driver blade 26 shown in FIG. 2. The driver blade 26b includes a plurality of lift teeth 82b formed along an edge 74b of the driver blade 26b. In particular, the plurality of lift teeth 82b extend from the edge 74b in a direction transverse to a longitudinal axis 58b. Each one of the lift teeth 74b includes an end portion 92. Each of the end portions 92, except for the end portion 92 of a lowermost tooth 82b′ of the driver blade 26b, has the same shape. In particular, the end portion 92 of the lowermost tooth 82b′ has a rounded shape. In one example, the rounded shape of the end portion 92 of the lowermost tooth 82b′ is configured to cooperate with a shape of a roller on the lifter assembly (not shown). In addition, the driver blade 26b includes a plurality of projections 86 extending from a second edge 78b of the driver blade 26b.

Conventionally, a forging and/or machining process is used to manufacture driver blades like those shown in FIGS. 2-3B. However, in the illustrated embodiment, an insert molding process, such as a one-shot metal injection molding (“MIM”) process, is used to manufacture the driver blade 26, 26a, 26b. In such a one-shot MIM process, the driver blade 26, 26a, 26b is made of a first material 110 (e.g., a metal or metal alloy) having a first hardness. The first hardness of the first material 110 is chosen to be at least a minimum value, and at least as hard as the components of the lifter assembly in contact with the lift teeth 82, 82a, 82b to reduce the wear imparted to the driver blade 26, 26a, 26b during use of the fastener driver 10. In one embodiment, the first material 110 includes a ferrous alloy composition. For example, the ferrous alloy composition may comprise an alloy of Carbon, Chromium, Iron, Manganese, Molybdenum, Silicon, and/or Vanadium. In the illustrated embodiment of the driver blade 26, 26a, 26b the ferrous allow composition consists essentially of (by weight): between 0.45% and 0.55% Carbon, between 3% and 3.5% Chromium, between 92% and 94.9% Iron, between 0.2% and 0.9% Manganese, between 1.3% and 1.8% Molybdenum, between 0.2% and 1% Silicon, and between 0.2% and 0.3% Vanadium.

In another embodiment, the driver blade 26, 26a, 26b may be formed using more than one material such that the driver blade 26, 26a, 26b is manufactured using a multiple-shot MIM process. For example, the body 66, 66a, 66b of the driver blade 26, 26a, 26b may be made from the first material 110 having the first hardness, and the lift teeth 82, 82a, 82b (and optionally the projections 86) may be made from a second material 114 having a second, different hardness. In this example, the MIM process is a two-shot MIM process. The first and second materials 110, 114 are chosen such that the second hardness is greater than the first hardness. Accordingly, the hardness of the lift teeth 82, 82a, 82b is greater than the hardness of the body 66, 66a, 66b to reduce the wear imparted to the lift teeth 82, 82a, 82b during use of the fastener driver 10. Because the dissimilar materials 110, 114 of the body 66, 66a, 66b and the lift teeth 82, 82a, 82b, respectively, are conjoined or integrally formed during the two-shot MIM process, a secondary manufacturing process for connecting the lift teeth 82, 82a, 82b to the body 66, 66a, 66b is unnecessary. In one embodiment, the second material 114 may also include a ferrous alloy composition.

In other embodiments of the driver blade 26, 26a, 26b, other portions may be made from dissimilar materials to impart different material properties (e.g., hardness) to the respective portions of the driver blade 26, 26a, 26b. For example, the second end 94, 94a, 94b of the driver blade 26, 26a, 26b, which impacts the fasteners during a fastener driving operation, may be made from a harder material than the remainder of the body 66, 66a, 66b.

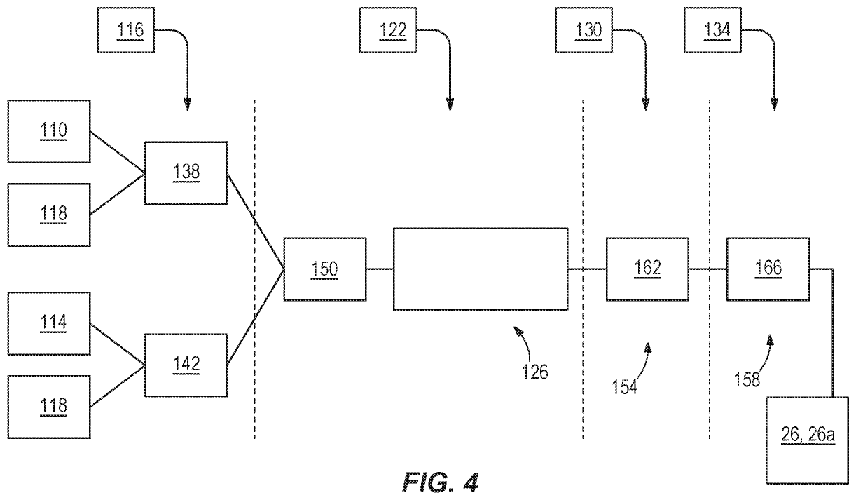

With reference to FIG. 4, the MIM process includes in sequence a feedstock mixing process 116 to mix the first material 110 with a binder composition 118, an injection molding process 122 using a mold 126, a debinding process 130 to eliminate the binder composition 118, and a heat treating process 134.

During the feedstock mixing process 116, the binder composition 118 is added to the first material 110 to facilitate processing through the injection molding process 122. As a result, the first material 110, which is in a powder form, is homogeneously mixed with the binder composition 118 to provide a first feedstock mixture 138 of a determined consistency. If it is a two-shot MIM process, the second material 114, which is also in a powder form, is also homogeneously mixed with the binder composition 118 to provide a second feedstock mixture 142 with substantially the same consistency as the first mixture 138. In the illustrated embodiment of the driver blade 26, 26a, 26b, the binder composition 118 includes a thermoplastic binder. Alternatively, the binder composition 118 may include other appropriate binder compositions (e.g., wax). The amount of binder composition 118 in each of the first and second feedstock mixtures 138, 142 is chosen to match the shrink rates of the body 66, 66a, 66b and the lift teeth 82, 82a, 82b respectively, during the sintering process 166 described below.

The injection molding process 122 includes processing the first and the second feedstock mixtures 138, 142 through an injection molding machine 150. Particularly, the process 122 includes injecting the first feedstock mixture 138 into the mold 126. If it is a two-shot MIM process, than the first feedstock mixture 138 is injected into a first portion of the mold 126, and the second feedstock mixture 142 is injected into a second portion of the mold 126. Upon completion of the injection molding process 122, a temporary or rough (otherwise known in the MIM industry as a “green”) driver blade 154 is produced that includes the first material 110 (and the second material 114 if it is a two-shot MIM process) and the binder composition 118. The “green” driver blade 154 is larger than the final driver blade 26, 26a, 26b due to the presence of the binder composition 118.

After the injection molding process 122, the “green” driver blade 154 is removed from the mold 126 and proceeds through the debinding process 130. The debinding process 130 eliminates the binder composition 118. During the debinding process 130, the “green” driver blade 154 transforms into a “brown” driver blade 158 (as it is known in the MIM industry) that only includes the first material 110 (and the second material 114 if it is a two-shot MIM process). In the illustrated embodiment, the debinding process 130 includes a chemical wash 162. Alternatively, the debinding process 130 may include a thermal vaporization process to remove the binder composition 118 from the “green” driver blade 154. The “brown” driver blade 158 is fragile and porous with the absence of the binder composition 118.

To reduce the porosity of the “brown” driver blade 158, the heat treating process 134 is performed to atomically diffuse the “brown” driver blade 158 to form the final tool bit 26, 26a, 26b. The heat treating process 134 exposes the “brown” driver blade 158 to an elevated temperature to promote atomic diffusion allowing atoms to interact and fuse together. In the illustrated embodiment, the heat treating process 134 includes a sintering process 166. Alternatively, the debinding process 130 and the heat treating process 134 may be combined as a single process such that, at lower temperatures, thermal vaporization will occur during the debinding process 130 to eliminate the binder composition 118. And, at higher temperatures, atomic diffusion will reduce the porosity in the “brown” driver blade 158 to yield the final, finished driver blade 26, 26a, 26b.

In some embodiments, the sintering process 166 includes a hot isostatic pressing (HIP) process that utilizes high pressure and temperature for a predetermined amount of time to impart a higher density to a part, such as the driver blade 26, 26a, 26b. In one example, the “brown” driver blade 158 is positioned in a high temperature furnace, which is enclosed in a pressure vessel. Any voids within the “brown” driver blade 158 collapse and fuse together under the high pressure and temperature to eliminate any defects within the “brown” driver blade 26, 26a, 26b. As such, the driver blade 26, 26a, 26b subjected to the HIP process may have an increase in density, a decrease in porosity throughout the driver blade 26, 26a, 26b and/or a decrease in micro-cracking.

The MIM process allows the driver blade 26, 26a, 26b to be manufactured having a relatively complex shape without a post-forming process (i.e., machining), thus reducing the cost in comparison to other manufacturing processes such as forging and machining, for example. Furthermore, with a multi-step MIM process, different portions of the driver blade 26, 26a, 26b may be made from dissimilar materials to impart different material properties (e.g., hardness) to the respective portions of the driver blade 26, 26a, 26b. Thus, performance and wear characteristics of the driver blade 26, 26a, 26b may be improved without the attendant cost of using multiple different manufacturing and assembly processes for separately forming, and then joining, the different portions of the driver blade 26, 26a, 26b.

Various features of the invention are set forth in the following claims.

What is claimed is:

1. A driver blade for use with a powered fastener driver, the driver blade comprising:
an elongated body defining a longitudinal axis, the body including
a top surface and a bottom surface opposite the top surface,
a first edge extending between the top surface and the bottom surface; and
a plurality of teeth formed along the first edge and extending in a direction transverse to the longitudinal axis,
wherein the driver blade is manufactured using a metal injection molding process.

2. The driver blade of claim 1, wherein the body is made of a first material, and wherein the metal injection molding process is a one-shot metal injection molding process.

3. The driver blade of claim 2, wherein the first material includes a ferrous alloy composition.

4. The driver blade of claim 3, wherein the ferrous alloy composition comprises an alloy of Carbon, Chromium, Iron, Manganese, Molybdenum, Silicon, and/or Vanadium.

5. The driver blade of claim 3, wherein the ferrous allow composition consists essentially of, by weight, between 0.45% and 0.55% Carbon, between 3% and 3.5% Chromium, between 92% and 94.9% Iron, between 0.2% and 0.9% Manganese, between 1.3% and 1.8% Molybdenum, between 0.2% and 1% Silicon, and between 0.2% and 0.3% Vanadium.

6. The driver blade of claim 1, wherein the body is made of a first material and the teeth are made of a second material, and wherein the metal injection molding process is a two-shot metal injection molding process wherein the body and the teeth are conjoined without an additional manufacturing step.

7. The driver blade of claim 6, wherein the first material and the second material each include a ferrous alloy composition.

8. The driver blade of claim 1, wherein the body includes a first end having a threaded post for connection to a piston of the powered fastener driver.

9. The driver blade of claim 8, wherein the body includes a second end opposite the first end, and wherein the second end is oriented perpendicular to the longitudinal axis.

10. The driver blade of claim 1, wherein the body includes a second edge extending between the top surface and the bottom surface, wherein the second edge is positioned on an opposite side of the longitudinal axis as the first edge, and wherein the driver blade further comprises a plurality of projections formed along the second edge and extending in a direction transverse to the longitudinal axis.

11. A method of manufacturing a driver blade for use with a powered fastener driver, the method comprising:
mixing a first material in powder form with a binder composition to yield a first feedstock mixture;
injecting the first feedstock mixture into a mold to form a rough driver blade;
removing the binder composition from the rough driver blade; and
heat treating the rough driver blade to reduce the porosity of the rough driver blade to yield a finished driver blade that is usable in the powered fastener driver.

12. The method of claim 11, wherein the first material is a ferrous alloy composition.

13. The method of claim 12, wherein the ferrous alloy composition comprises an alloy of Carbon, Chromium, Iron, Manganese, Molybdenum, Silicon, and/or Vanadium.

14. The method of claim 13, wherein the ferrous allow composition consists essentially of, by weight, between 0.45% and 0.55% Carbon, between 3% and 3.5% Chromium, between 92% and 94.9% Iron, between 0.2% and 0.9% Manganese, between 1.3% and 1.8% Molybdenum, between 0.2% and 1% Silicon, and between 0.2% and 0.3% Vanadium.

15. The method of claim 11, further comprising:
mixing a second material in powder form with a second binder composition to yield a second feedstock mixture; and
injecting the second feedstock mixture into the mold to form the rough driver blade.

16. The method of claim 15, wherein injecting the first feedstock mixture includes injecting the first feedstock mixture into a first portion of the mold to form a first portion of the rough driver blade, and wherein injecting the second feedstock mixture includes injecting the second feedstock mixture into a second portion of the mold to form a separate, second portion of the rough driver blade.

17. The method of claim 16, wherein the first portion of the rough driver blade is an elongated body of the driver blade, and wherein the second portion of the rough driver blade is a plurality of teeth formed along an edge of the elongated body.

18. The method of claim 11, wherein removing the binder composition from the rough driver blade includes passing the rough driver blade through a chemical wash or using a thermal vaporization process.

19. The method of claim 11, wherein heat treating the rough driver blade includes sintering the rough driver blade.

20. The method of claim 19, wherein sintering the rough driver blade includes using a hot isostatic pressing process to increase the density of the rough driver blade.
